(19) United States
(12) Patent Application Publication
(10) Pub. No.: US 2025/0181095 A1
(43) Pub. Date: Jun. 5, 2025

(54) ELECTRONIC DEVICE USING A POWER DESIGN WITH IMPROVED POWER SUPPLY REJECTION RATIO AND METHOD FOR OPERATING THE POWER DESIGN

(71) Applicant: MEDIATEK INC., Hsinchu City (TW)

(72) Inventors: Yen-An LIN, Hsinchu City (TW); Chih-Chen LI, Hsinchu City (TW); Yi-An CHEN, Hsinchu City (TW); Ming-Shao TSAI, Hsinchu City (TW)

(21) Appl. No.: 18/960,102

(22) Filed: Nov. 26, 2024

Related U.S. Application Data
(60) Provisional application No. 63/604,235, filed on Nov. 30, 2023.

(51) Int. Cl. G05F 1/575; H02M 1/00; H02M 3/158

(52) U.S. Cl. CPC G05F 1/575; H02M 1/0045; H02M 3/158

(57) ABSTRACT

An electronic device using a power design with a good power supply rejection ratio (PSRR) is shown. The electronic device includes a voltage regulator, a low dropout regulator (LDO), an application, and a feedback control path. The voltage regulator generates a system voltage. The LDO is coupled to the voltage regulator to receive the system voltage for generation of an LDO output voltage. The application is coupled to the LDO to receive the LDO output voltage. The feedback control path couples a flag signal to the voltage regulator. In response to the flag signal being asserted, the voltage regulator pulls up the system voltage. The flag signal is asserted before the load current of the application reaches a heavy load current level.

### CROSS REFERENCE TO RELATED APPLICATIONS

This application claims the benefit of U.S. Provisional Application No. 63/604,235, filed Nov. 30, 2023, the entirety of which is incorporated by reference herein.

### BACKGROUND OF THE INVENTION

### Field of the Invention

The present invention relates to a power design of an electronic device.

### Description of the Related Art

FIG. 1 depicts a conventional power design for an electronic device 100. An external power source is converted to a system voltage Vsys by the buck converter 102. The buck converter 102 usually uses an inductor to transform power. The system voltage Vsys provided by the inductor L is converted by the low dropout regulator (LDO) 104, to generate an LDO output voltage VLDO to drive an application 106 (e.g., a computing module, such as a system-on-chip, abbreviated as SoC). The LDO 104 between the buck converter 102 and the application 106 is provided for noise rejection. The current driving the application 106 is the load current Iload.

As shown in FIG. 1, the conventional feedback control of such a power design can be implemented by a VLDO feedback control circuit 108, a Vgs feedback control circuit 110, or a load sensing circuit 112. The VLDO feedback control circuit 108 compares the detected LDO output voltage VLDO with a reference voltage. When the compared result shows a change of the LDO output voltage VLDO, the buck converter 102 is triggered to adjust the system voltage Vsys to compensate for the change of the LDO output voltage VLDO. The Vgs feedback control circuit 110 detects the change of a gate-to-source voltage Vgs of a power transistor of the LDO 104 and, accordingly, operates the buck converter 102 to compensate for the change of the detected Vgs and provide the required load current Iload to the application 106. The load sensing circuit 112 is operative to detect the load current Iload of the application 106. Based on the detected load current Iload, the load sensing circuit 112 operate the buck converter 102 to compensate for the loading change of the application 106.

In summary, the feedback control (108/110/112) illustrated in FIG. 1 is performed based on the detected changes.

FIG. 2 shows waveforms of the signals shown in FIG. 1. In the first time interval T1, the application 106 operates in a light load status. The load current Iload is at a light load current level. The system voltage Vsys and the LDO output voltage VLDO are stable. Meanwhile, a feedback control signal FBent for operating the buck converter 102 to compensate for the detected changes is de-asserted, and an inductor current IL through the inductor of the buck converter 102 is small. After the first time interval T1, the application 106 switches from the light load status to a heavy load status. The load current Iload increases to a heavy load current level. The system voltage Vsys and the LDO output voltage VLDO fall down. In response to the detected changes of VLDO/Vgs/Iload, the feedback control (108/110/112) illustrated in FIG. 1 asserts the feedback control signal FBent to operate the buck converter 102 to increase the inductor current IL and thereby the system voltage Vsys is pulled up. It takes time for the system voltage Vsys to reach a proper value. In this example, the system voltage Vsys reaches the proper value in the third time interval T3.

As shown, because the system voltage Vsys and the LDO output voltage VLDO significantly fall down before the compensation triggered by the slow-response feedback control signal FBent really takes effect, a voltage headroom (Vsys-VLDO) of the LDO 104 is too small to keep a power supply rejection ratio (PSRR) during the time interval T2. The good PSRR is not achieved until compensation proceeds to the time interval T3.

A novel power design with good performance on PSRR is called for.

### BRIEF SUMMARY OF THE INVENTION

In this disclosure, the compensation is triggered earlier.

An electronic device in accordance with an exemplary embodiment of the disclosure includes a voltage regulator, a low dropout regulator (LDO), an application, and a feedback control path. The voltage regulator generates a system voltage. The LDO is coupled to the voltage regulator to receive the system voltage for generation of an LDO output voltage. The application is coupled to the LDO to receive the LDO output voltage. The feedback control path couples a flag signal to the voltage regulator. In response to the flag signal being asserted, the voltage regulator pulls up the system voltage. The flag signal is asserted before the load current of the application reaches a heavy load current level.

In an exemplary embodiment, the feedback control path is arranged between the application and the voltage regulator. The application is a computing module that asserts the flag signal prior to a load switching, wherein the application schedules the load switching to switch the application itself from a light load status to a heavy load status.

In another exemplary embodiment, the electronic device further has a differentiator circuit, which builds the feedback control path. The differentiator circuit is coupled to the LDO to detect a significant drop in the LDO output voltage. In response to a drop in the LDO output voltage, the differentiator circuit asserts the flag signal.

A method for operating a power design of an electronic device is also introduced in the disclosure. The method includes: generating a system voltage using a voltage regulator; operating an LDO to convert the system voltage to an LDO output voltage to drive an application; and providing a flag signal to the voltage regulator. In response to the flag signal being asserted, the voltage regulator pulls up the system voltage. The flag signal is asserted before the load current of the application reaches a heavy load current level.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts the conventional power design of an electronic device 100;

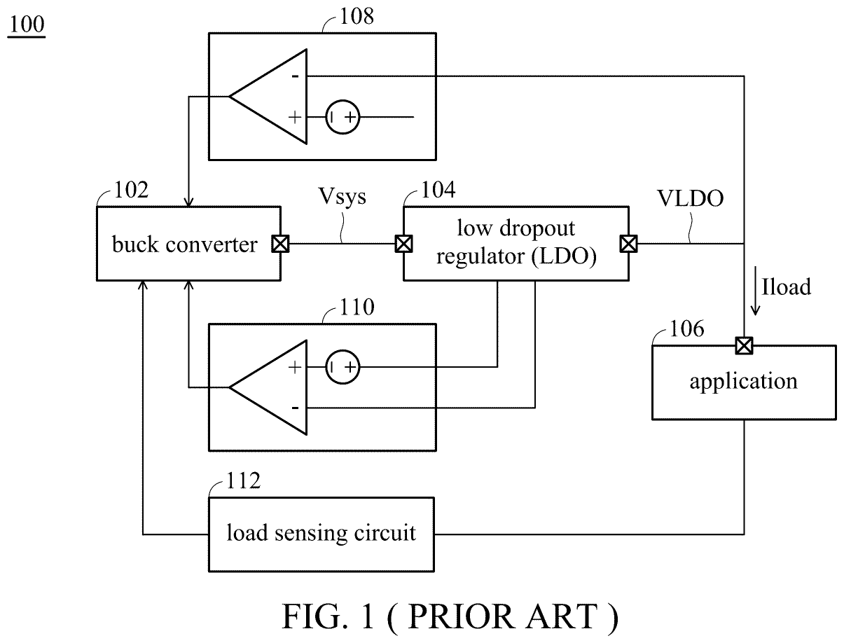

FIG. 2 shows waveforms of the signals shown in FIG. 1;

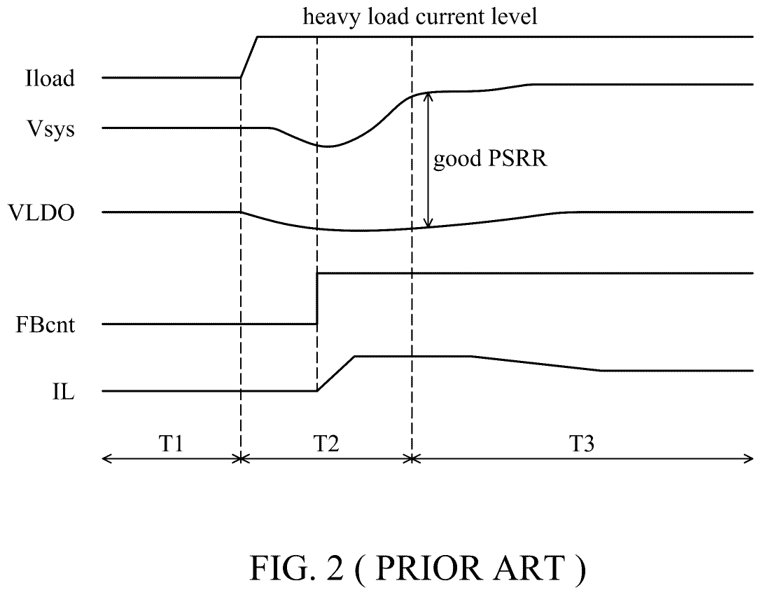

FIG. 3 depicts a power design of an electronic device 300 in accordance with an exemplary embodiment of the disclosure;

FIG. 4 shows waveforms of the signals of the power design of FIG. 3, wherein the feedback control is implemented through the flag signal IRQ1;

FIG. 5 shows waveforms of the signals of the power design of FIG. 3, wherein the feedback control is implemented through the flag signal IRQ2; and

FIG. 6 illustrates an electronic device 600 in accordance with an exemplary embodiment of the disclosure.

### DETAILED DESCRIPTION OF THE INVENTION

The following description enumerates various embodiments of the disclosure, but is not intended to be limited thereto. The actual scope of the disclosure should be defined according to the claims. The various blocks may be implemented by special circuits. The circuit components may be directly connected to each other without additional components as the circuit illustrated in the figures. Or, there may be some additional components coupled between the illustrated circuit components.

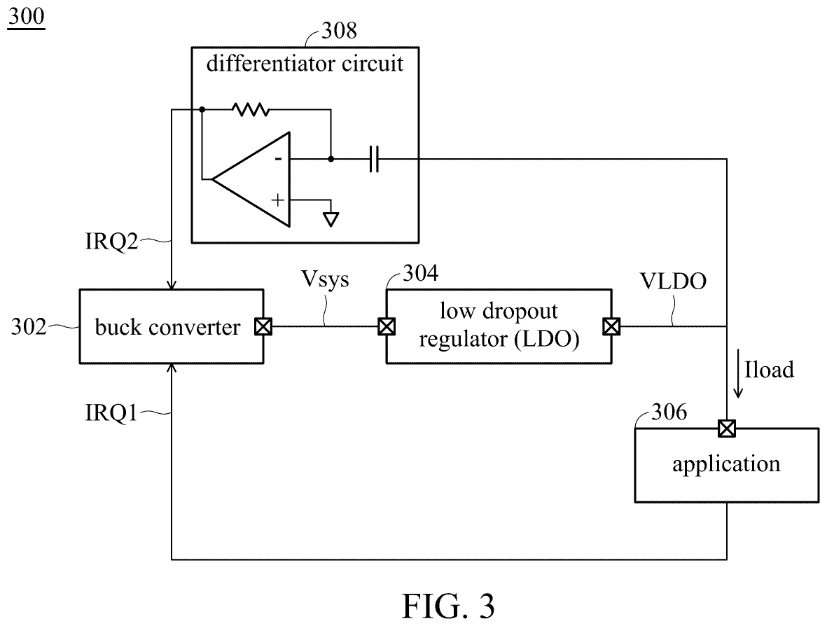

FIG. 3 depicts a power design of an electronic device 300 in accordance with an exemplary embodiment of the disclosure, which includes a buck converter 302, a low dropout regulator (LDO) 304, an application 306, and a differentiator circuit 308. An external power source is converted to a system voltage Vsys by the buck converter 302. The LDO 304 converts the system voltage Vsys to an LDO output voltage VLDO to drive the application 306. The current driving the application 306 is the load current Iload. The application 306 may be any computing module, such as a system-on-chip (SoC).

In response to a schedule for switching the load of the application 306 from a light load status to a heavy load status, the application 306 itself may assert a flag signal IRQ1 to instruct the buck converter 302 to pre-adjust the system voltage Vsys and, accordingly, the LDO 304 modifies the LDO output voltage VLDO in advance to cope with the upcoming load switching. The direct connection between the application 306 and the buck converter 302 is a feedback control path that couples the flag signal IRQ1 from the application 306 to the buck converter 302.

Alternatively, the load switching from the light load status to the heavy load status may be timely detected by the differentiator circuit 308. The LDO output voltage VLDO is coupled to the differentiator circuit 308. In response to a significant drop in the LDO output voltage VLDO, the differentiator circuit 308 immediately asserts a flag signal IRQ2 to instruct the buck converter 302 to adjust the system voltage Vsys, and thereby the LDO 204 modifies the LDO output voltage VLDO to deal with the heavy load status of the application 306. Another feedback control path is built by the differentiator circuit 308 to couple the flag signal IRQ2 to the buck converter 302.

Specifically, the flag signal IRQ1/IRQ2 is asserted before the load current Iload reaches a heavy load current level.

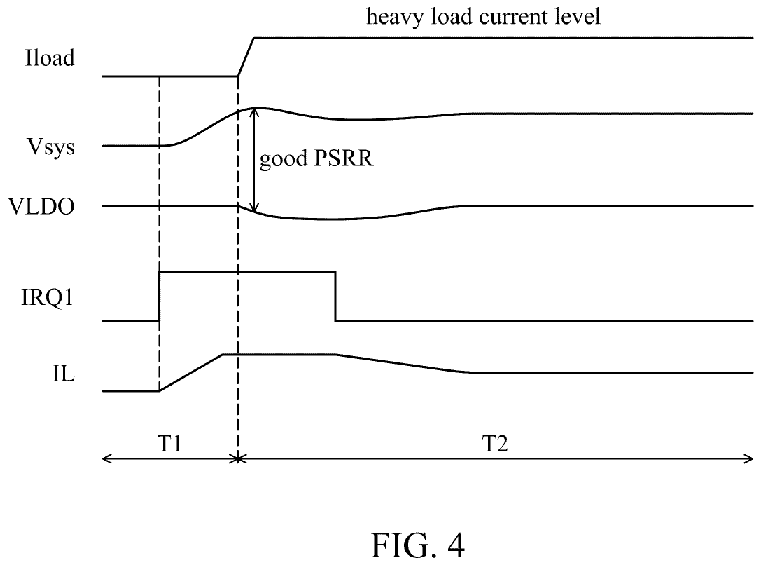

FIG. 4 shows waveforms of the signals of the power design of FIG. 3, wherein the feedback control is implemented through the flag signal IRQ1. In the first time interval T1, the application 306 operates in a light load status, and the load current Iload is at a light load current level. The application 306 schedules to switch from the light load status to the heavy load status after the first time interval T1. Prior to the second time interval T2 that the load switching really happens, the application 306 asserts the flag signal IRQ1 (in the first time interval T1) to instruct the buck converter 302 to increase its inductor current IL to pre-adjust the system voltage Vsys. In response to the pre-adjusted system voltage Vsys, the LDO 304 modifies the LDO output voltage VLDO in advance to cope with the upcoming load switching (referring to the low to high switching presented in the load current Iload). Benefiting from the pre-adjusted system voltage Vsys, the LDO output voltage VLDO does not drop significantly, which results in a good power supply rejection ratio (PSRR) of the LDO 304 during the time interval T2. The application 306 asserts the flag signal IRQ1 before the load current Iload reaches the heavy load current level, and thereby a good PSRR is immediately achieved when scheduled load switching really happens.

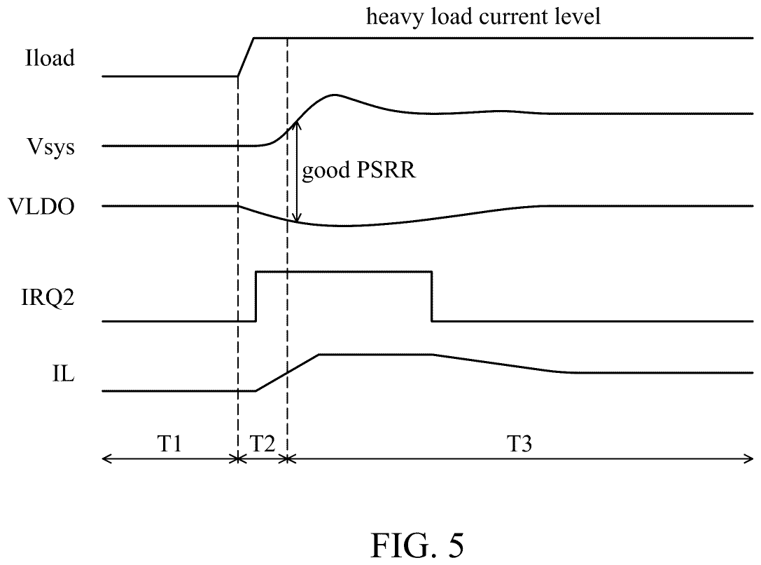

FIG. 5 shows waveforms of the signals of the power design of FIG. 3, wherein the feedback control is implemented through the flag signal IRQ2. In the first time interval T1, the application 306 operates in a light load status, and the load current Iload is at a light load current level. After the first time interval T1, the application 306 is switched from the light load status to the heavy load status, and a significant drop in the LDO output voltage VLDO is detected by the differentiator circuit 308. Thus, the differentiator circuit 308 asserts the flag signal IRQ2 immediately in the second time interval T2. In response to the asserted flag signal IRQ2, the buck converter 302 increases its inductor current IL to adjust the system voltage Vsys and, accordingly, the LDO 304 timely modifies the LDO output voltage VLDO to cope with the load switching (referring to the low to high switching presented in the load current Iload). Benefiting from the fast transient time of the differentiator circuit 308, the system voltage Vsys is timely pulled up, which results in a good PSRR of the LDO 304 during the time interval T3. The differentiator circuit 308 asserts the flag signal IRQ2 before the load current Iload reaches a heavy load current level, and thereby a good PSRR is timely achieved even the load switching happens.

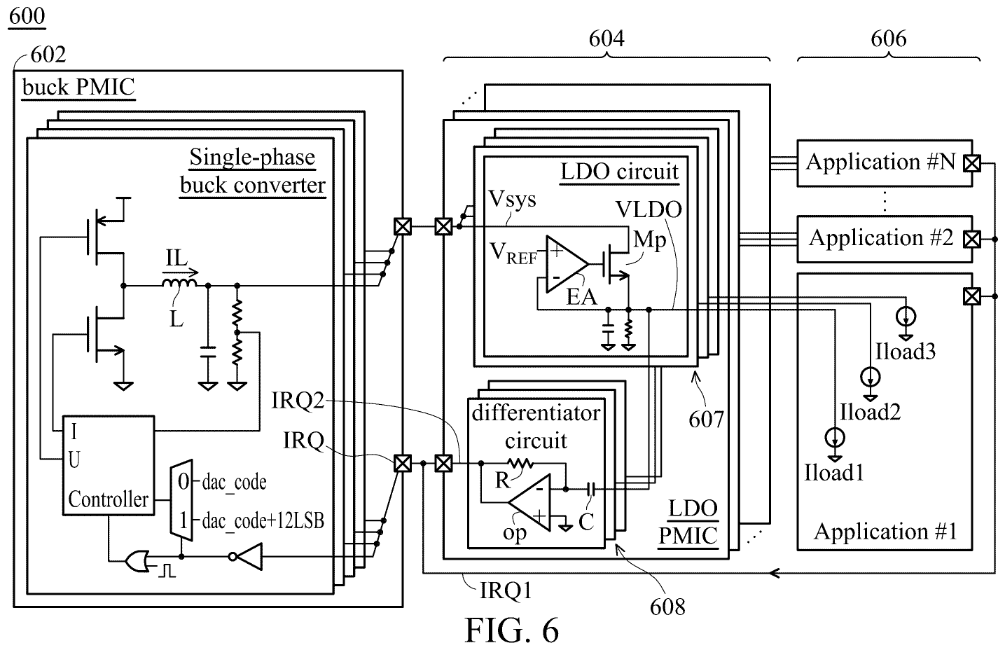

FIG. 6 illustrates an electronic device 600 in accordance with an exemplary embodiment of the disclosure, which includes a buck power management integrated circuit (buck PMIC) 602, a plurality LDO PMICs (indicated by 604), and a plurality applications #1˜#N (indicated by 606) corresponding to the LDO PMICs 604 one by one.

The buck PMIC 602 includes single-phase buck converters in the different phases. Each single-phase buck converter uses an inductor L for power transform. The current flowing through the inductor L is the aforementioned inductor current IL. The buck PMIC 602 has a pin IRQ for receiving the flag signal IRQ1/IRQ2. In response to the flag signal IRQ1/IRQ2 being asserted, the inductor current IL increases and the system voltage Vsys is pulled up.

Each LDO PMIC includes a plurality of LDO circuits 607 and a plurality of differentiator circuits 608 paired with the LDO circuits 607. Each LDO circuit receives the system voltage Vsys from the buck PMIC 602, and uses a power transistor Mp and an error amplifier EA to transform the system voltage Vsys to an LDO output voltage VLDO. The different LDO circuits 607 on the same LDO PMIC are provided to satisfy the various power requirements (referring to the different load currents Iload1, Iload2 and Iload3) of the corresponding application. Each application corresponding to one LDO PMIC may be a computing module (e.g., an SoC) which is capable of asserting a flag signal IRQ1 before the scheduled load switching (from a light load status to a heavy load status). An SoC may has a pin to output the flag signal IRQ1. As shown, the flag signal IRQ1 is coupled to the IRQ pin of the buck PMIC 602.

As for the differentiator circuits 608, each differentiator circuit detects the changes of its corresponding LDO output voltage VLDO, and asserts the flag signal IRQ2 in response to detected significant VLDO drop. The flag signal IRQ2 is also coupled to the IRQ pin of the buck PMIC 602.

In FIG. 6, the power transistor Mp of the LDO circuit is a p-channel Metal-Oxide-Semiconductor Field-Effect Transistor (PMOS) having a drain receiving the system voltage Vsys, and a source providing the LDO output voltage VLDO. The error amplifier EA controls the gate of the power transistor Mp. The error amplifier EA has a negative input terminal ‘−’ coupled to the source of the PMOS Mp, and a positive input terminal ‘+’ receiving a reference voltage V_{REF}. In the other exemplary embodiments, there may be some modifications in the design of the LDO circuit.

In FIG. 6, the differentiator circuit includes an operational amplifier op, a resistor R coupled between a negative input terminal ‘−’ and an output terminal of the operational amplifier op, and a capacitor C coupling the LDO output voltage VLDO to the negative input terminal ‘−’ of the operational amplifier op. The flag signal IRQ2 is output by the output terminal of the operational amplifier op. In the other exemplary embodiments, there may be some modifications in the design of the LDO circuit.

In the illustrated example, the flag signals generated by the different applications #1˜#N are all coupled to the same IRQ pin of the buck PMIC 602. The flag signals generated by the different a differentiator circuits are all coupled to the same IRQ pin of the buck PMIC 602, too.

In some exemplary embodiments, the buck converter is replaced by another kind of voltage regulator (e.g., any DC-DC converter). It is not intend to limit the generation of the system voltage Vsys.

Any electronic device with load switching compensation triggered before the load current Iload has been changed to a heavy load current level should be interpreted as within the scope of the disclosure.

A method for operating a power design of an electronic device is also introduced in the disclosure. The method includes: generating a system voltage Vsys using a voltage regulator (302); operating an LDO 304 to convert the system voltage Vsys to an LDO output voltage VLDO to drive an application 306; and providing a flag signal IRQ1/IRQ2 to the voltage regulator (302). In response to the flag signal IRQ1/IRQ2 being asserted, the voltage regulator (302) pulls up the system voltage Vsys. The flag signal IRQ1/IRQ2 is asserted before the load current Iload of the application 306 reaches a heavy load current level.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a voltage regulator, generating a system voltage;
a low dropout regulator (LDO), coupled to the voltage regulator to receive the system voltage for generation of an LDO output voltage;
an application, coupled to the LDO to receive the LDO output voltage; and
a feedback control path, coupling a flag signal to the voltage regulator;
wherein:
in response to the flag signal being asserted, the voltage regulator pulls up the system voltage; and
the flag signal is asserted before a load current of the application reaches a heavy load current level.

2. The electronic device as claimed in claim 1, wherein:
the feedback control path is arranged between the application and the voltage regulator; and
the application is a computing module that asserts the flag signal prior to a load switching, wherein the application schedules the load switching to switch the application itself from a light load status to a heavy load status.

3. The electronic device as claimed in claim 2, wherein:
the application is a system-on-chip (SoC); and
the SoC has a first pin operative to output the flag signal.

4. The electronic device as claimed in claim 3, further comprising:
a first power management integrated chip (PMIC), providing the voltage regulator,
wherein the first PMIC has a second pin coupled to the first pin of the SoC to receive and couple the flag signal to the voltage regulator.

5. The electronic device as claimed in claim 4, wherein:
the voltage regulator is a buck converter that uses an inductor to transform power into the system voltage; and
in response to the flag signal being asserted, the buck converter increases an inductor current of the inductor to pull up the system voltage.

6. The electronic device as claimed in claim 4, further comprising:
a second PMIC, providing the LDO,
wherein the second PMIC is coupled to the first PMIC to receive the system voltage required by the LDO, and is coupled to the SoC to provide the LDO output voltage generated by the LDO to the SoC.

7. The electronic device as claimed in claim 6, wherein:
the LDO includes a power transistor and an error amplifier;
the power transistor is a p-channel Metal-Oxide-Semiconductor Field-Effect Transistor (PMOS) having a drain receiving the system voltage, and a source providing the LDO output voltage; and
the error amplifier has a negative input terminal coupled to the source of the PMOS, a positive input terminal receiving a reference voltage, and an output terminal coupled to a gate of the power transistor.

8. The electronic device as claimed in claim 1, further comprising:
a differentiator circuit, building the feedback control path,
wherein:
the differentiator circuit is coupled to the LDO to detect a significant drop in the LDO output voltage; and
in response to the significant drop in the LDO output voltage, the differentiator circuit asserts the flag signal.

9. The electronic device as claimed in claim 8, wherein:
the differentiator circuit has an operational amplifier, a resistor, and a capacitor;
the capacitor couples the LDO output voltage to a negative input terminal of the operational amplifier;
the resistor is coupled between the negative input terminal of the operational amplifier and an output terminal of the operational amplifier; and
the flag signal is provided from the output terminal of the operational amplifier.

10. The electronic device as claimed in claim 8, wherein:
the voltage regulator is a buck converter that uses an inductor to transform power into the system voltage; and
in response to the flag signal being asserted by the differentiator circuit, the buck converter increases an inductor current of the inductor to pull up the system voltage.

11. The electronic device as claimed in claim 8, wherein:
the LDO includes a power transistor and an error amplifier;
the power transistor is a p-channel Metal-Oxide-Semiconductor Field-Effect Transistor (PMOS) having a drain receiving the system voltage, and a source providing the LDO output voltage; and
the error amplifier has a negative input terminal coupled to the source of the PMOS, a positive input terminal receiving a reference voltage, and an output terminal coupled to a gate of the power transistor.

12. A method for operating a power design of an electronic device, comprising:
generating a system voltage using a voltage regulator;
operating a low dropout regulator (LDO) to convert the system voltage to an LDO output voltage to drive an application; and
providing a flag signal to the voltage regulator;
wherein:
in response to the flag signal being asserted, the voltage regulator pulls up the system voltage; and
the flag signal is asserted before a load current of the application reaches a heavy load current level.

13. The method as claimed in claim 12, wherein:
the application is a computing module that asserts the flag signal prior to a load switching, wherein the application schedules the load switching to switch the application itself from a light load status to a heavy load status.

14. The method as claimed in claim 12, further comprising:
providing a differentiator circuit,
wherein:
the differentiator circuit is coupled to the LDO to detect a significant drop in the LDO output voltage; and
in response to the significant drop in the LDO output voltage, the differentiator circuit asserts the flag signal.

15. The method as claimed in claim 13, wherein:
the differentiator circuit has an operational amplifier, a resistor, and a capacitor;
the capacitor couples the LDO output voltage to a negative input terminal of the operational amplifier;
the resistor is coupled between the negative input terminal of the operational amplifier and an output terminal of the operational amplifier; and
the flag signal is provided from the output terminal of the operational amplifier.
